(19) United States
(12) Patent Application Publication
(10) Pub. No.: US 2013/0066601 A1
(43) Pub. Date: Mar. 14, 2013

(54) PRODUCT ATTRIBUTE VISUALIZER

(71) Applicant: Saravanan Palanivel, Decatur, IL (US)

(72) Inventor: Saravanan Palanivel, Decatur, IL (US)

(73) Assignee: CGN & Associates, Inc., Peoria, IL (US)

(21) Appl. No.: 13/611,551

(22) Filed: Sep. 12, 2012

Related U.S. Application Data
(60) Provisional application No. 61/534,145, filed on Sep. 13, 2011.

(51) Int. Cl. G06F 17/50

(52) U.S. Cl. 703/1

(57) ABSTRACT

An embodiment according to the invention provides a means by which attributes of a complex product including multiple parts may be visualized rapidly across multiple aspects of the product, thereby permitting rapid improvement of the design process and realizing business efficiencies. An embodiment according to the invention provides such features in a lightweight format that supplements existing visualization tools, which may have received design data from heavier Computer-Aided Design (CAD) systems.

### RELATED APPLICATION

This application claims the benefit of U.S. Provisional Application No. 61/534,145, filed on Sep. 13, 2011, the entire teachings of which application are incorporated herein by reference.

### BACKGROUND OF THE INVENTION

Automated design tools such as Computer-Aided Design (CAD) software are typically used to assist in the design of physical products that include a large number of component parts. Despite the availability of such automated tools, managing the design of such products remains a complex business task. For example, designers and managers often need to assess aspects of the product that are affected by attributes of many different component parts in an assembly, such as the cost per weight of the parts, suppliers of the parts, the thickness and mass of the parts, the pressure exerted on the parts, and other attributes of the product. The resulting analysis can be complex, time-consuming and costly. Decisions regarding the attributes of the parts of the product can have a critical impact not just on the design of the product, but also on the success of the business that is selling such products. There is therefore an ongoing need to permit the rapid and effective analysis of products that include a large number of components.

### SUMMARY OF THE INVENTION

In accordance with an embodiment of the invention, there is provided a device for permitting the visualization, by a visualization tool, of attribute levels for a physical product comprising a plurality of physical parts. The device comprises an input interface configured to receive parts data relating to representation of the plurality of physical parts, the parts data comprising a plurality of colors corresponding to the attribute levels of the plurality of physical parts, each attribute level being associated with an individual physical part of the plurality of physical parts; an attribute processor configured to transform the parts data relating to representation of the plurality of physical parts to a visualization tool attribute format that permits color representation by the visualization tool of at least one attribute level of the attribute levels of the plurality of physical parts, each attribute level in the color representation being associated with an individual physical part of the plurality of physical parts; and an output interface configured to transmit the parts data in the visualization tool attribute format to the visualization tool for visualization of the at least one attribute level of the plurality of physical parts of the physical product.

In further, related embodiments, the input interface may be further configured to receive the parts data from a spreadsheet module. The output interface may be further configured to transmit the parts data in the visualization tool attribute format to a stand-alone visualization tool that separately is configured to receive visualization data for the physical product, such as JT format data, from a computer-aided design module. The parts data in the visualization tool attribute format may be readable by the visualization tool as properties data corresponding to the plurality of physical parts, the properties data in the visualization tool not normally including the attribute levels, each attribute level in the color representation being readable by the visualization tool as a property of an individual physical part of the plurality of physical parts. The attribute processor may be further configured to transform the parts data from a spreadsheet module data format to the visualization tool attribute format. The parts data in the spreadsheet module data format may comprise parts data automatically generated by the visualization tool from visualization data for the plurality of physical parts for use by the spreadsheet module, such as a parts list generated by the visualization tool. The parts data in the spreadsheet module data format may comprise the plurality of colors corresponding to the attribute levels of the plurality of physical parts, the plurality of colors having been manually entered into the spreadsheet module data format for the plurality of physical parts, or having been automatically entered into the spreadsheet module data format for the plurality of physical parts from a source other than the visualization tool.

In further, related embodiments, the parts data received by the input interface may comprise a parts list for the plurality of physical parts. The parts data in the visualization tool attribute format transmitted by the output interface may permit the display by the visualization tool of a filtering of the at least one attribute level of the plurality of physical parts of the physical product. The parts data in the visualization tool attribute format may comprise at least one of: cost per weight, supplier, thickness, material, mass, pressure, cost, price, part number, part name and a visualization parameter for the plurality of physical parts of the physical product. The visualization parameter may comprise at least one of: transparency, shininess, color and specularity. The attribute processor may be further configured to transform the parts data from a spreadsheet module data format to the visualization tool attribute format, the visualization tool attribute format comprising data in an extensible markup language (XML) format, which may comprise data for a triple of numbers corresponding to each color of the plurality of colors received by the input interface for the attribute levels of the plurality of physical parts, and may comprise data for a text string corresponding to each field of the parts data received by the input interface other than the plurality of colors received by the input interface. The visualization tool attribute format may comprise, for each part of the plurality of physical parts, data identifying the part and, for each color of the plurality of colors received by the input interface for the attribute levels for each such part, data for a triple of numbers corresponding to each such color for such part and a text string corresponding to each field of the parts data received by the input interface other than the plurality of colors received by the input interface for such part.

In further, related embodiments, the visualization tool attribute format may permit the color representation by the visualization tool of the at least one attribute level of the plurality of physical parts using the visualization tool's own graphical user interface (GUI). The visualization tool attribute format may permit the color representation by the visualization tool of at least one of: a progression of states of the plurality of physical parts of the physical product over time; a design comparison of more than one version of the physical product; a representation for use in cost comparison of the plurality of physical parts of the physical product; and a representation for use in standardization of parts of the physical product. The device may be configured to be executed from within a spreadsheet module and the input interface may be further configured to receive the parts data from the spreadsheet module. The visualization tool attribute format may permit color representation by the visualization tool of the at least one attribute level based on having the visualization tool import data in the visualization tool attribute format into the visualization tool. The data imported into the visualization tool may comprise data in an extensible markup language (XML) format, and may permit viewing of the attribute levels for each part of the plurality of physical parts by a user gesture, such as right-clicking, for each such part on a graphical user interface (GUI). The color representation may be implemented in the visualization tool by applying the data imported into the visualization tool to the plurality of physical parts. The parts data in the visualization tool attribute format may permit color representation by the visualization tool of the at least one attribute level using more than one color scheme. The attribute processor may permit the color representation by the visualization tool of the at least one attribute level without permanently changing visualization data for the physical product. The attribute processor may permit the color representation by the visualization tool of at least one of: cost per weight, supplier, thickness, material, mass, pressure, cost, price, part number, part name and transparency for the plurality of physical parts of the physical product.

Related methods and non-transient computer-readable storage media having computer-readable code stored thereon are provided.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram illustrating the context in which a product attribute visualizer according to an embodiment of the invention may be used.

FIG. 2 is a diagram of data entered into a spreadsheet program for subsequent input to a product attribute visualizer in accordance with an embodiment of the invention.

FIGS. 3A-3D are diagrams of a display of a product with attributes visualized based on using a product attribute visualizer in accordance with an embodiment of the invention.

FIG. 4 is a diagram of a display of a product with multiple attributes visualized based on using a product attribute visualizer in accordance with an embodiment of the invention.

FIG. 5 is a diagram of a display of a product with the progression over time of an attribute visualized based on using a product attribute visualizer in accordance with an embodiment of the invention.

FIG. 6 is a diagram showing a listing of visualization tool attribute format data, which may be generated by a product attribute visualizer in accordance with an embodiment of the invention.

### DETAILED DESCRIPTION OF THE INVENTION

A description of example embodiments of the invention follows.

An embodiment according to the invention provides a means by which attributes of a complex product including multiple parts may be visualized rapidly across multiple aspects of the product, thereby permitting rapid improvement of the design process and realizing business efficiencies. An embodiment according to the invention provides such features in a lightweight format that supplements existing visualization tools, which may have received design data from heavier Computer-Aided Design (CAD) systems.

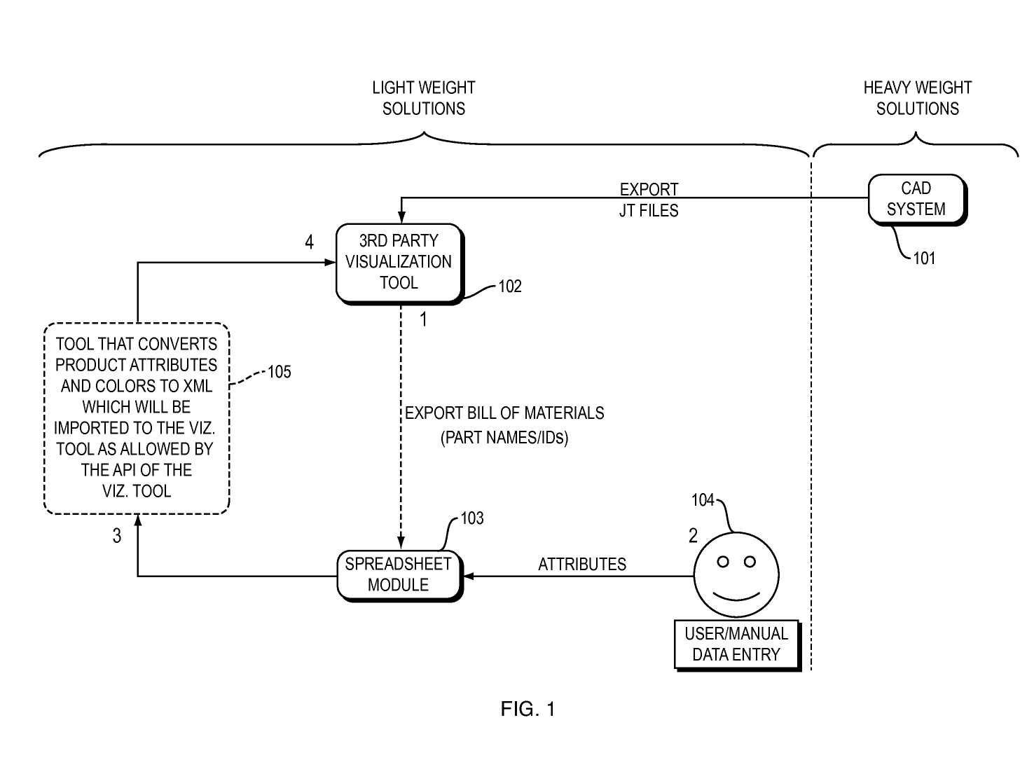

FIG. 1 is a block diagram illustrating the context in which a product attribute visualizer according to an embodiment of the invention may be used. A Computer-Aided Design (CAD) system 101 is used to design a complex physical product that includes a large number of component parts. The CAD system 101 exports design data in a three-dimensional data format, for example the .jt or “JT format” developed by Siemens Product Life Cycle Management Software, Inc., a division of Siemens AG of Munich, Germany, to a third-party visualization tool 102. Other three-dimensional data formats may be used. The CAD system 101 may, for example, be Creo Elements/Pro sold by Parametric Technology Corporation of Needham, Mass., U.S.A., or another CAD system. The third-party visualization tool 102 may, for example, be TeamCenter Visualization Mockup or TeamCenter Mobility sold by Siemens Product Life Cycle Management Software, Inc., or another visualization tool. The visualization tool 102 may export a portion of a bill of materials, i.e., at least a list of part names or identification numbers for the component parts of the product, to a spreadsheet program 103. Such a part list may, for example, be in the form of a text file or a comma-separated values (CSV) format file. The spreadsheet program 103 may, for example, be Microsoft® Excel, sold by Microsoft Corporation of Redmond, Wash., U.S.A., although other spreadsheets may be used. Alternatively, the spreadsheet program 103 need not receive the list of part names or identification numbers automatically from the visualization tool 102, but may instead have the part names or numbers entered manually or receive them automatically from another source. A user 104 then enters into the spreadsheet program 103 values for attributes of interest for each part of the product, and enters into the spreadsheet program 103 a color associated with an attribute level for the attributes of each part that are to be visualized. A product attribute visualizer 105 in accordance with an embodiment of the invention then receives the user-entered data from the spreadsheet program 103 and converts it to an attribute format for the visualization tool 102 for the parts to be visualized. For example, the product attribute visualizer 105 in accordance with an embodiment of the invention may be run as an add-in in the spreadsheet program 103, and may convert the user-entered data in the spreadsheet 103 to attribute format data for the visualization tool 102 in an extensible markup language (XML) format. The visualization tool 102 can then be used to import the attribute format data (for example, attribute data in an XML format or another format) and fill the attributes for the part as allowed by the application programming interface (API) of the visualization tool 102. The visualization tool 102 may then be used to visualize and filter the attributes of the product that were entered into the spreadsheet 103 as highlighted colors of the parts in the visualization tool 102, thereby permitting rapid design and business analysis of the physical product based on using a lightweight product attribute visualizer 105.

An embodiment according to the invention may permit the product attributes to be filled as “attributes” of the parts of the product, where normally the “attributes” of the parts do not include such attributes in the visualization tool 102. For example, in TeamCenter Visualization Mockup, the “attributes” of a part normally include only a few items, such as the part number, part name and designer of the part. An embodiment according to the invention is able to fill those attributes with data that allows a user 104 to rapidly visualize in color, and filter, the attributes of the parts that are of interest.

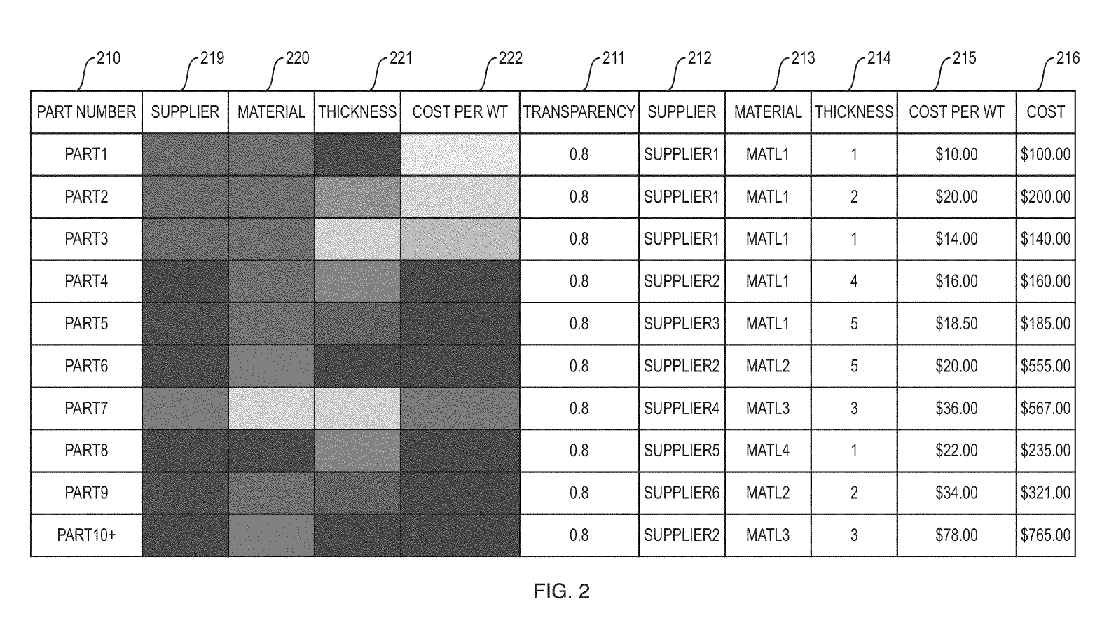

FIG. 2 is a diagram of data entered into a spreadsheet program 103 (of FIG. 1) for subsequent input to a product attribute visualizer 105 in accordance with an embodiment of the invention. As used herein, “parts data” refers to data (which may include colors) relating to the representation of a plurality of physical parts of a physical product. The parts data in FIG. 2 includes several fields 210-216 that are filed with non-color data rather than color, and several fields 219-222 that are filled with colors. Different numbers of fields may be used than those shown. All of these fields 210-216 and 219-222 may be filled into the spreadsheet program 103 manually by a user, or the fields 210-216 and 219-222 may be filled automatically from the visualization tool 102 or another source. The fields 210-216 include the part number 210, the transparency 211 to be used in displaying the attribute colors on the part, the supplier 212, the material 213 for the part, the thickness 214, the cost per weight 215 of the part, and the cost 216 for the part. A visualization parameter for the part, such as transparency, shininess, color, specularity or other visualization parameter for the part may be included. Such visualization parameters may be determined by the visualization tool 102 that is being used. It will be appreciated that other fields may be used as desired, for example a part name, price, pressure exerted upon the part, date, model and other attributes of the part. The color fields 219-222 may include the supplier 219, the material 220, the thickness 221, the cost per weight 222, and any other desired colors. It will be appreciated that other color fields may be used as desired, for example the cost, price, pressure exerted upon the part, or other attributes of the part. The user fills the color fields 219-222 based on a range of attribute levels for each attribute that are to be associated with a given color. The association with a given color may be pre-established or may be assigned automatically or at random. For example, in the thickness field 221, a pre-established range of thicknesses may have been identified with the color purple, while another range of thicknesses may have been associated with a lighter shade of purple, another range of thicknesses with light blue, another range of thicknesses with light green, and so forth. By filling in the spreadsheet 103 (see FIG. 1) with attribute levels in the appropriate colors, a user enables the product attribute visualizer 105 to subsequently permit the display of these colors on the parts using the visualization tool 102. It will be appreciated that fewer or more attributes, and different attributes, may be used than the examples given above, and can be any properties related to the parts.

In accordance with an embodiment of the invention, after a user has filled the spreadsheet 103 as desired for the parts, the user may then run the product attribute visualizer 105 as a macro, add-in or other routine from the spreadsheet program 103. Alternatively, the product attribute visualizer 105 may operate as a program that is independent of the spreadsheet program 103. Any appropriate programming language may be used for the product attribute visualizer 105. The product attribute visualizer 105 uses the parts data from the spreadsheet to create data in a visualization tool attribute format, for example in an XML format. The data in the visualization tool attribute format may then be imported by the visualization tool 102, and may then be applied to the parts data for the parts that is already present in the visualization tool 102, using the visualization tool 102's graphical user interface (GUI). The GUI of the visualization tool 102 may then permit viewing of the attributes that were entered into the spreadsheet program 103 by the user, and then filtering of those attributes by the level of those attributes. For example, a user may request to view all parts with a cost per weight greater than $1.50 per pound, and these parts will then be displayed by the visualization tool 102 with attribute levels (such as cost per weight levels) in the appropriate colors that were previously entered into the spreadsheet program 103.

In accordance with an embodiment of the invention, the product attribute visualizer 105 may be used to permit the standardization of parts, for example, visualizing the pressures of hoses and other connections; to permit the visualizing of trends in a machine, such as how the states of the machine vary over time or how the gates or paint on a product change or have changed over time; to permit prioritization, including cost reduction (such as targeting where to spend time on a design); to permit comparison between designs; to provide a visual cost comparison; to permit interactive idea generation sessions; to permit design simplification workshops; to provide progress reports and charts; to perform a commonality analysis; to perform supplier rationalization; to perform a material analysis; to perform a plate utilization analysis; and to permit other analysis of a collection of parts.

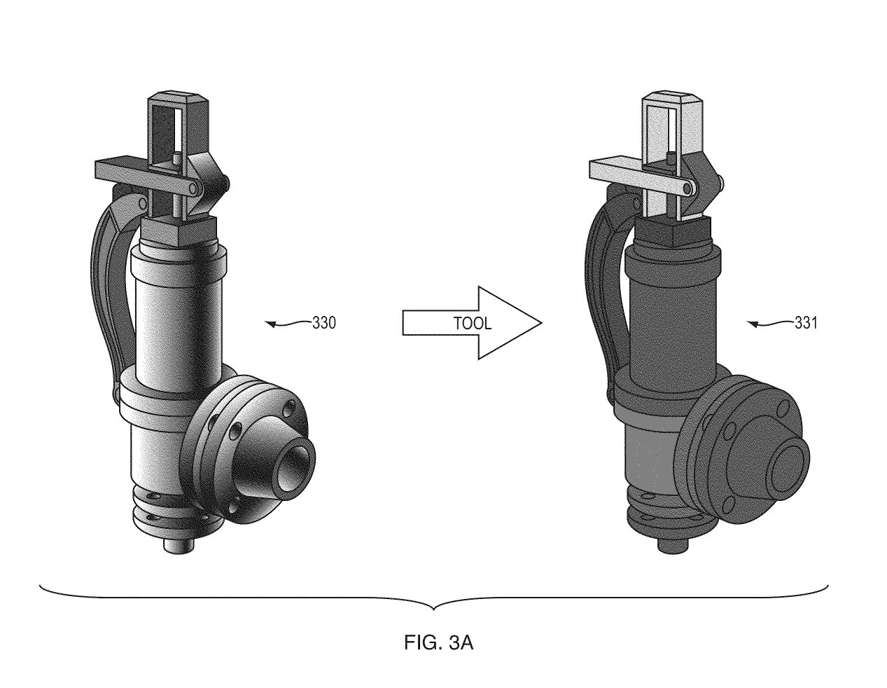

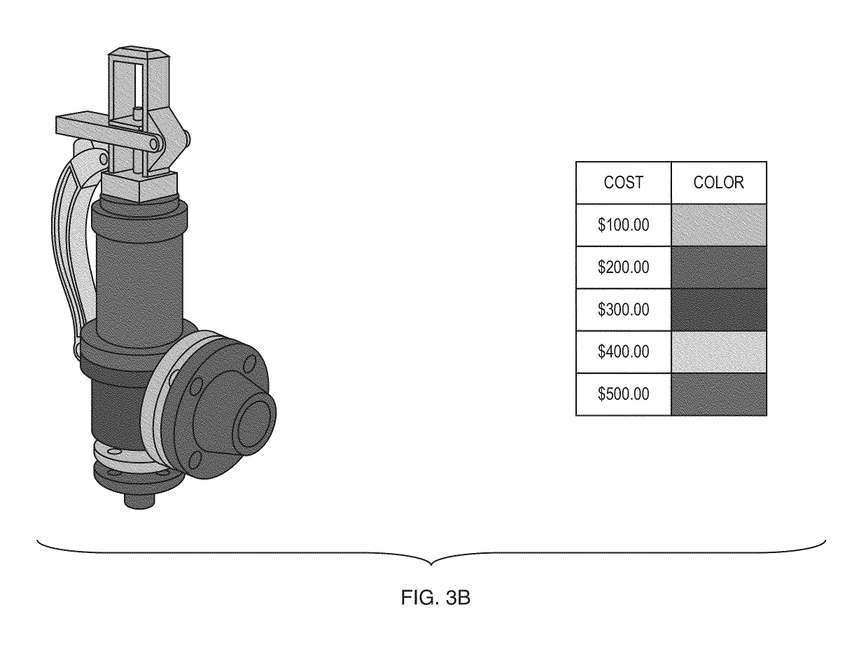

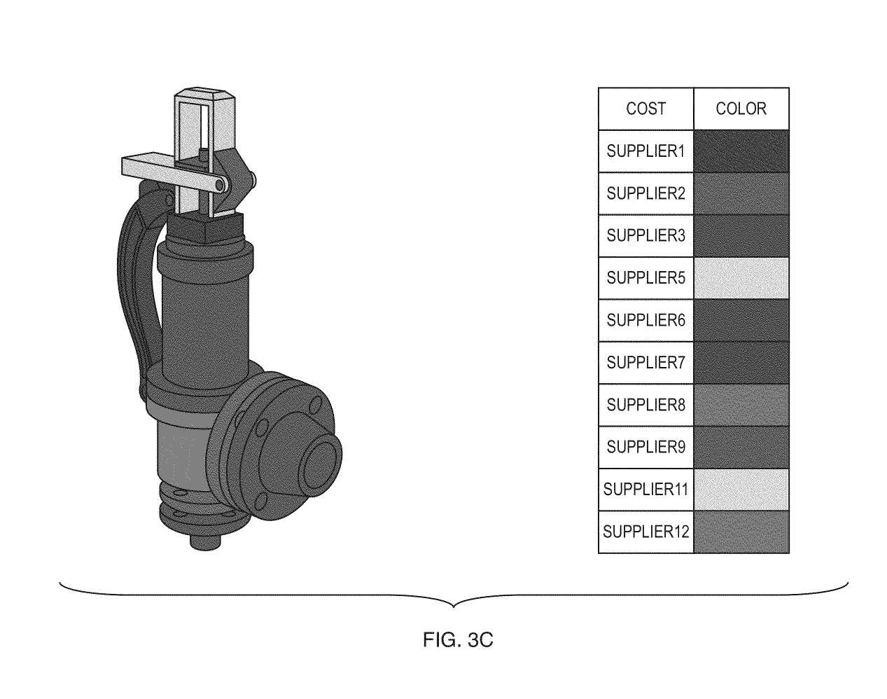

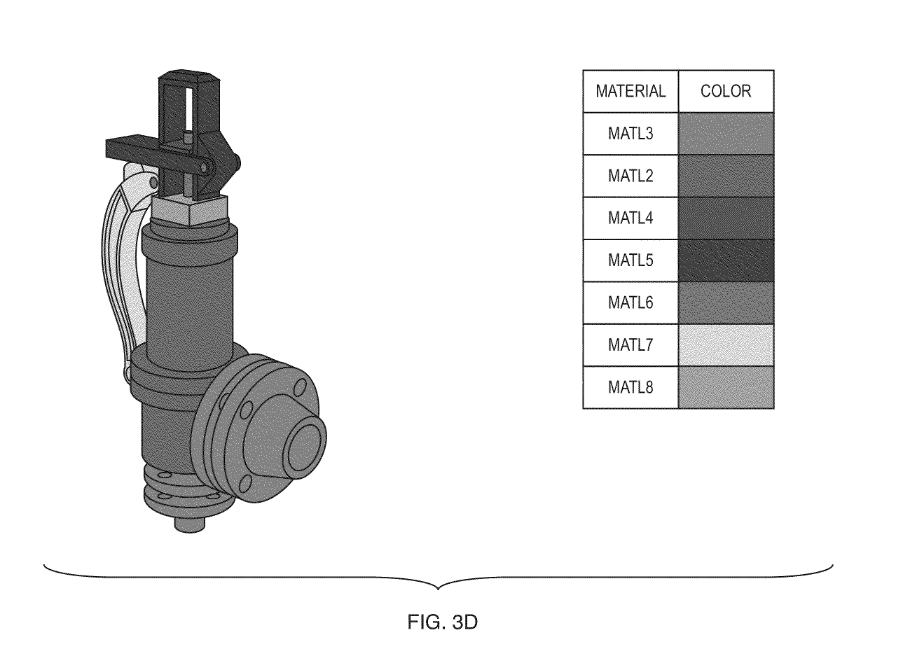

FIGS. 3A-3D is a diagram of a display of a product with attributes visualized based on using a product attribute visualizer in accordance with an embodiment of the invention. In FIG. 3A, the parts are shown before 330 and after 331 applying the “supplier” attribute to the parts using the visualization tool 102 (see FIG. 1), which has imported the visualization tool attribute format data for the “supplier” attribute using the product attribute visualizer 105. The visualization tool attribute format data may, for example, be attribute data in an XML format appropriate for being applied as an “attribute” in the visualization tool 102. The colors based on the attribute data may be applied in “one click,” or at most several clicks, for example using a mouse or other device in communication with a computer operating the visualization tool, by applying the attribute format data to the parts in the visualization tool. In addition, parts models may be color coded by more than one color scheme, in accordance with an embodiment of the invention; for example, both a “supplier” attribute with its associated color levels and a “thickness” attribute with its associated color levels may be applied to a parts model. Further, attributes may be viewed in rapid succession, for example in a design review workshop; for example, a “supplier” attribute may be viewed as color levels applied to the parts, followed by a “material” attribute viewed as color levels applied to the parts, followed by a “thickness” attribute applied to the parts, followed by a “cost per weight” applied to the parts. FIG. 3B shows a “cost” attribute viewed as color levels applied to the parts, FIG. 3C shows a “supplier” attribute viewed as color levels applied to the parts and FIG. 3D shows a “material” attribute viewed as color levels applied to the parts.

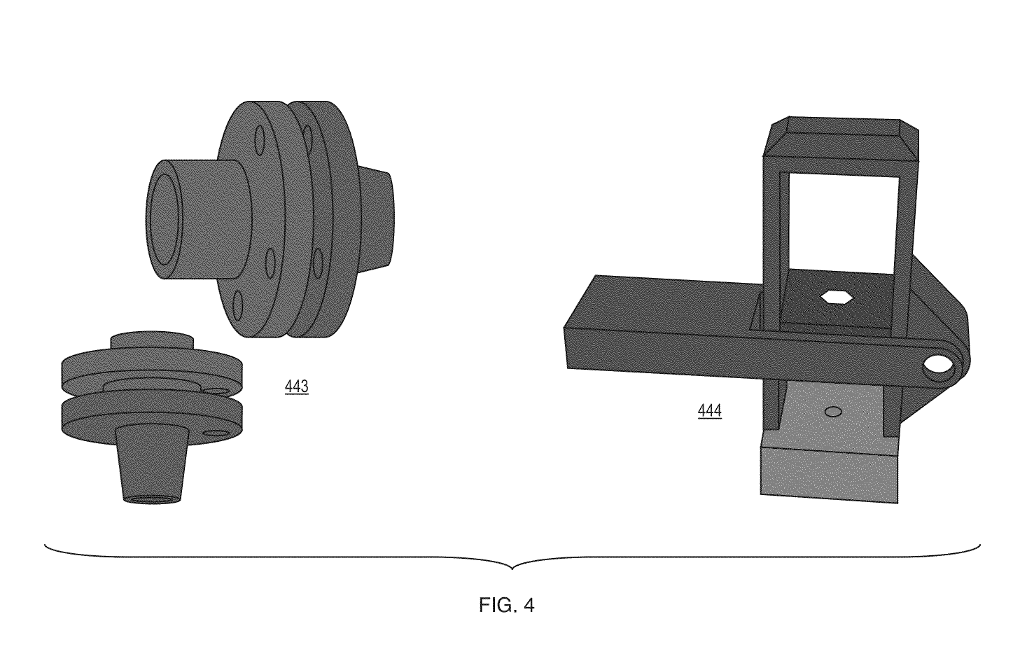

FIG. 4 is a diagram of a display of a product with multiple attributes visualized based on using a product attribute visualizer in accordance with an embodiment of the invention. Here, the product attribute visualizer permits a combination of color visualization with filtering by attributes, thereby enabling a multi-dimensional analysis of the product. For example, view 443 of FIG. 4 shows a product filtered by parts that are flanges, and then colored by the “supplier” attribute in that filtered display. This permits a comparison of similar parts versus supplier, thereby providing an opportunity for cost reduction by supplier consolidation. View 444 of FIG. 4 shows a product filtered by plates, and then colored by the “material” attribute in that filtered display. This permits a comparison of similar parts versus material, thereby providing an opportunity for design simplification by material consolidation. Other combinations of color visualization with filtering may be permitted by the product attribute visualizer.

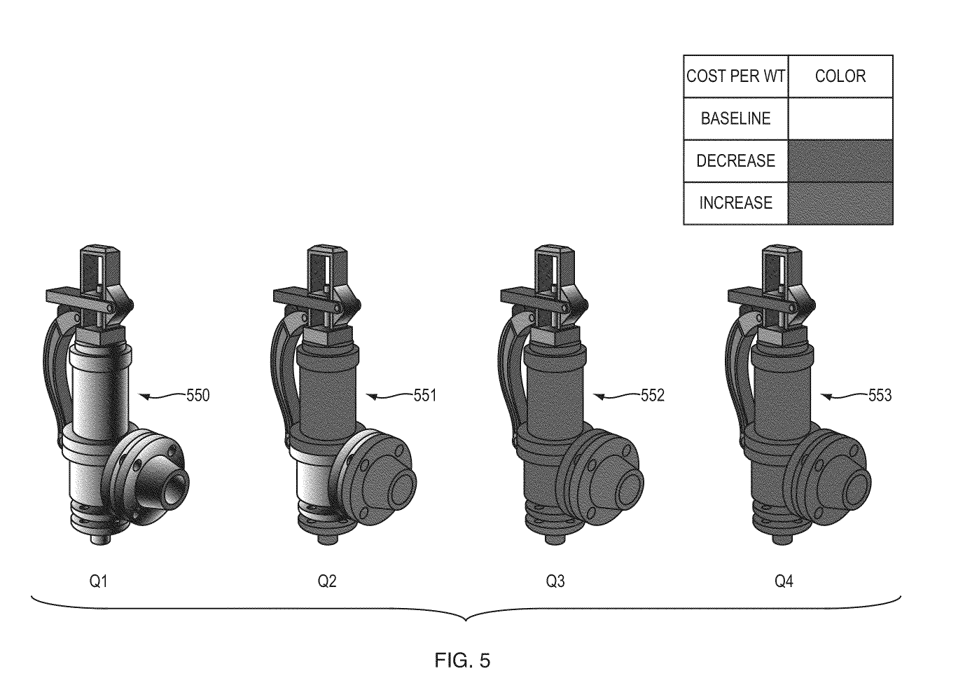

FIG. 5 is a diagram of a display of a product with the progression over time of an attribute visualized based on using a product attribute visualizer in accordance with an embodiment of the invention. Here, the product attribute visualizer permits an attribute, such as cost per weight, to be visualized at different instances in time 550-553, thereby permitting analysis of the progress of the attribute over time. Other trends in state of a design, or other project activities, may be reviewed.

Further, a product attribute visualizer in accordance with an embodiment of the invention may be used to permit a comparison of models side by side, identifying similarities and variations between designs, by displaying the different models side by side with attributes applied to them based on using the product attribute visualizer. Further, focused component studies may be conducted by visualizing multiple different assemblies or parts filtered by the same attribute. For example, eight different parts may be viewed, each having the “supplier” attribute applied, and then each having the “material” attribute applied, the “cost per weight” attribute applied, or another attribute applied. Other analyses may be performed.

A product attribute visualizer in accordance with an embodiment of the invention may produce a 70% or more reduction in time as compared with a manual process for coloring a parts model, and permits multiple color schemes to be applied in such a shorter time. Further, the count of parts in an assembly has minimal effect on the overall coloring time using an embodiment according to the invention, whereas the time increases exponentially with the count of parts when a manual coloring process is used.

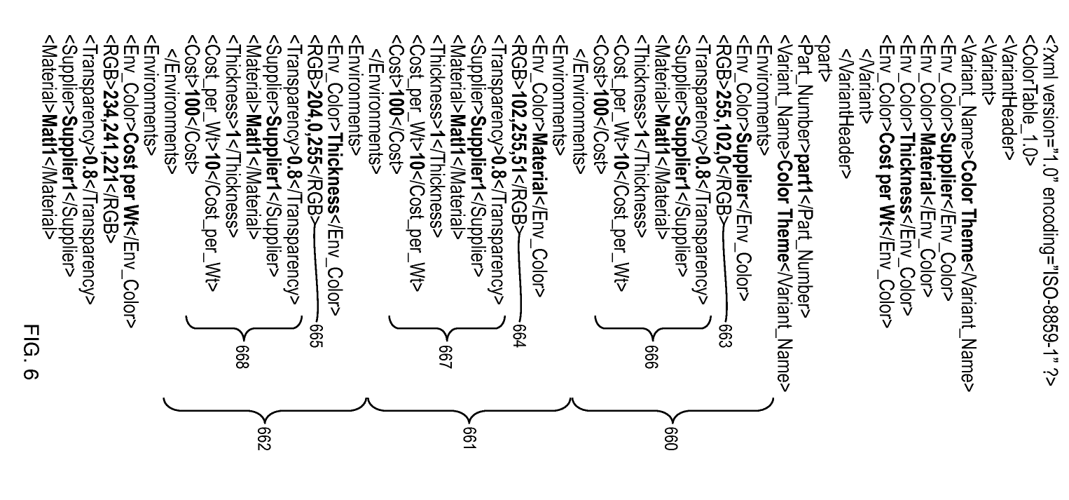

FIG. 6 is a diagram showing a listing of visualization tool attribute format data, which may be generated by a product attribute visualizer in accordance with an embodiment of the invention. Here, the product attribute visualizer 105 (see FIG. 1) converts the data entered into the spreadsheet program 103, for example an Excel spreadsheet, into attribute data in an XML format appropriate for being applied as an “attribute” in the visualization tool 102, for example TeamCenter Visualization Mockup. It will be appreciated that other spreadsheet and visualization tool programs may be used, and other data formats. In FIG. 6, the data from the spreadsheet of FIG. 2 has been converted into the XML format that, once imported by the visualization tool 102, will be recognized by the visualization tool 102 as relating to “attributes” of the parts in a way that permits the subsequent visualization of those attributes using the visualization tool 102. The algorithm followed by the product attribute visualizer in performing the conversion of the spreadsheet parts data to the visualization tool attribute format may, for example, be as follows: read cell value from the spreadsheet; create XML header; read color values; convert color values to RGB triple of numbers; convert non-color cells values to text strings; check for characters that are unacceptable and remove them; progress one cell at a time through each line of the spreadsheet; cycle through all of the cells in the Excel file; and output the resulting XML file. For example, comparing the spreadsheet of FIG. 2 with the XML format data of FIG. 6, it can be seen that the line in the spreadsheet for the first part number 210 (of FIG. 2), which is part number “part1,” has its first three color cells in columns 219-221 specified using sections 660-662 of the XML format data of FIG. 6. For each color cell, the XML format data 660-662 begins by converting the color in column 219-221 in the spreadsheet to an RGB triple of numbers 663-665, and then repeats a text string 666-668 for the remaining non-color fields of the spreadsheet line that are in columns 211-216. The process repeats for each line of the spreadsheet until a complete XML file is output by the product attribute visualizer corresponding to the attribute data entered into the spreadsheet.

Once the visualization tool attribute format data has been created by a product attribute visualizer in accordance with an embodiment of the invention, it may then be imported into the visualization tool and applied to the collection of parts. In one example, this may be performed in the TeamCenter Visualization Mockup program as follows:

1. Click Model.
2. Goto Menu->Actions->Attributes->Preferences and select “All parts.”
3. Goto Menu->Actions->Attributes->Load Attribute file.
4. Selecte the XML file for the visualization tool attribute format data.
5. Goto Menu->Actions->Attributes->Apply Color Attributes.
6. Select the color set and click Apply.

It will be appreciated that other steps may be followed in other programs using an embodiment according to the invention. Further, in accordance with an embodiment of the invention, once the attribute format data has been imported into the visualization tool, it may be viewed by right-clicking or performing another user gesture on a user interface for the visualization tool. In addition, the attributes may be filtered using a “filter” function of the visualization tool, based on the attributes.

In accordance with an embodiment of the invention, a product attribute visualizer does not change an underlying design data file permanently, instead applying the attributes on top of the existing design data file. For example, a visualization tool may use the output of the product attribute visualizer to apply the attributes on top of an existing JT file, without permanently changing the JT file.

A product attribute visualizer in accordance with the invention has been described in which parts data is converted to a visualization tool attribute format. As used herein, an “input interface” is a portion of the product attribute visualizer that receives parts data relating to representation of a plurality of physical parts, including color levels corresponding to the attribute levels of the physical parts. Such an interface may, for example, be a portion of program code, operating on a computer processor, that extracts data from a spreadsheet program to be processed by the product attribute visualizer. As used herein, an “attribute processor” is a portion of the product attribute visualizer that transforms the parts data relating to representation of the plurality of physical parts to a visualization tool attribute format that permits color representation by the visualization tool of the attribute levels of the physical parts. For example, such a processor may be a portion of program code, operating on a computer processor. Further, as used herein, an “output interface” is a portion of the product attribute visualizer that transmits the parts data in the visualization tool attribute format to the visualization tool for visualization of the attribute levels of the physical parts. For example, such an interface may be a portion of program code, operating on a computer processor.

Portions of the above-described embodiments of the present invention can be implemented using one or more computer systems, for example to permit implementation of a product attribute visualizer. For example, the embodiments may be implemented using hardware, software or a combination thereof. When implemented in software, the software code can be stored on any form of non-transient computer-readable medium and loaded and executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, at least a portion of the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

In this respect, it should be appreciated that one implementation of the above-described embodiments comprises at least one computer-readable medium encoded with a computer program (e.g., a plurality of instructions), which, when executed on a processor, performs some or all of the above-discussed functions of these embodiments. As used herein, the term “computer-readable medium” encompasses only a non-transient computer-readable medium that can be considered to be a machine or a manufacture (i.e., article of manufacture). A computer-readable medium may be, for example, a tangible medium on which computer-readable information may be encoded or stored, a storage medium on which computer-readable information may be encoded or stored, and/or a non-transitory medium on which computer-readable information may be encoded or stored. Other non-exhaustive examples of computer-readable media include a computer memory (e.g., a ROM, a RAM, a flash memory, or other type of computer memory), a magnetic disc or tape, an optical disc, and/or other types of computer-readable media that can be considered to be a machine or a manufacture.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

While this invention has been particularly shown and described with references to example embodiments thereof, it will be understood by those skilled in the art that various changes in form and details may be made therein without departing from the scope of the invention encompassed by the appended claims.

1. A device for permitting the visualization, by a visualization tool, of attribute levels for a physical product comprising a plurality of physical parts, the device comprising:
an input interface configured to receive parts data relating to representation of the plurality of physical parts, the parts data comprising a plurality of colors corresponding to the attribute levels of the plurality of physical parts, each attribute level being associated with an individual physical part of the plurality of physical parts;
an attribute processor configured to transform the parts data relating to representation of the plurality of physical parts to a visualization tool attribute format that permits color representation by the visualization tool of at least one attribute level of the attribute levels of the plurality of physical parts, each attribute level in the color representation being associated with an individual physical part of the plurality of physical parts; and
an output interface configured to transmit the parts data in the visualization tool attribute format to the visualization tool for visualization of the at least one attribute level of the plurality of physical parts of the physical product.

2. A device according to claim 1, wherein the input interface is further configured to receive the parts data from a spreadsheet module.

3. A device according to claim 1, wherein the output interface is further configured to transmit the parts data in the visualization tool attribute format to a stand-alone visualization tool that separately is configured to receive visualization data for the physical product from a computer-aided design module.

4. A device according to claim 3, wherein the visualization data for the physical product received from the computer-aided design module comprises JT format data.

5. A device according to claim 1, wherein the parts data in the visualization tool attribute format is readable by the visualization tool as properties data corresponding to the plurality of physical parts, the properties data in the visualization tool not normally including the attribute levels, each attribute level in the color representation being readable by the visualization tool as a property of an individual physical part of the plurality of physical parts.

6. A device according to claim 1, wherein the attribute processor is further configured to transform the parts data from a spreadsheet module data format to the visualization tool attribute format.

7. A device according to claim 6, wherein the parts data in the spreadsheet module data format comprises parts data automatically generated by the visualization tool from visualization data for the plurality of physical parts for use by the spreadsheet module.

8. A device according to claim 7, wherein the automatically generated parts data comprises a parts list generated by the visualization tool.

9. A device according to claim 6, wherein the parts data in the spreadsheet module data format comprises the plurality of colors corresponding to the attribute levels of the plurality of physical parts, the plurality of colors having been manually entered into the spreadsheet module data format for the plurality of physical parts.

10. A device according to claim 6, wherein the parts data in the spreadsheet module data format comprises the plurality of colors corresponding to the attribute levels of the plurality of physical parts, the plurality of colors having been automatically entered into the spreadsheet module data format for the plurality of physical parts from a source other than the visualization tool.

11. A device according to claim 1, wherein the parts data received by the input interface comprises a parts list for the plurality of physical parts.

12. A device according to claim 1, wherein the parts data in the visualization tool attribute format transmitted by the output interface permits the display by the visualization tool of a filtering of the at least one attribute level of the plurality of physical parts of the physical product.

13. A device according to claim 1, wherein the parts data in the visualization tool attribute format comprise at least one of: cost per weight, supplier, thickness, material, mass, pressure, cost, price, part number, part name and a visualization parameter for the plurality of physical parts of the physical product.

14. A device according to claim 13, wherein the visualization parameter comprises at least one of: transparency, shininess, color and specularity.

15. A device according to claim 1, wherein the attribute processor is further configured to transform the parts data from a spreadsheet module data format to the visualization tool attribute format, the visualization tool attribute format comprising data in an extensible markup language (XML) format.

16. A device according to claim 15, wherein the visualization tool attribute format comprises data for a triple of numbers corresponding to each color of the plurality of colors received by the input interface for the attribute levels of the plurality of physical parts.

17. A device according to claim 16, wherein the visualization tool attribute format comprises data for a text string corresponding to each field of the parts data received by the input interface other than the plurality of colors received by the input interface.

18. A device according to claim 17, wherein the visualization tool attribute format comprises, for each part of the plurality of physical parts, data identifying the part and, for each color of the plurality of colors received by the input interface for the attribute levels for each such part, data for a triple of numbers corresponding to each such color for such part and a text string corresponding to each field of the parts data received by the input interface other than the plurality of colors received by the input interface for such part.

19. A device according to claim 1, wherein the visualization tool attribute format permits the color representation by the visualization tool of the at least one attribute level of the plurality of physical parts using the visualization tool's own graphical user interface (GUI).

20. A device according to claim 1, wherein the visualization tool attribute format permits the color representation by the visualization tool of at least one of: a progression of states of the plurality of physical parts of the physical product over time; a design comparison of more than one version of the physical product; a representation for use in cost comparison of the plurality of physical parts of the physical product; a representation for use in standardization of parts of the physical product.

21. A device according to claim 1, wherein the device is configured to be executed from within a spreadsheet module and the input interface is further configured to receive the parts data from the spreadsheet module.

22. A device according to claim 1, wherein the visualization tool attribute format permits color representation by the visualization tool of the at least one attribute level based on having the visualization tool import data in the visualization tool attribute format into the visualization tool.

23. A device according to claim 22, wherein the data imported into the visualization tool comprises data in an extensible markup language (XML) format.

24. A device according to claim 22, wherein the data imported into the visualization tool permits viewing of the attribute levels for each part of the plurality of physical parts by a user gesture for each such part on a graphical user interface (GUI).

25. A device according to claim 24, wherein the user gesture comprises right-clicking.

26. A device according to claim 22, wherein the color representation may be implemented in the visualization tool by applying the data imported into the visualization tool to the plurality of physical parts.

27. A device according to claim 1, wherein the parts data in the visualization tool attribute format permits color representation by the visualization tool of the at least one attribute level using more than one color scheme.

28. A device according to claim 1, wherein the attribute processor permits the color representation by the visualization tool of the at least one attribute level without permanently changing visualization data for the physical product.

29. A device according to claim 1, wherein the attribute processor permits the color representation by the visualization tool of at least one of: cost per weight, supplier, thickness, material, mass, pressure, cost, price, part number, part name and a visualization parameter for the plurality of physical parts of the physical product.

30.-59. (canceled)
